(19) United States
(12) Patent Application Publication
(10) Pub. No.: US 2020/0251698 A1
(43) Pub. Date: Aug. 6, 2020

(54) MULTI-TIERED BATTERY PACK AND LIQUID COOLANT COMMUNICATION METHOD FOR SAME

(71) Applicant: Ford Global Technologies, LLC, Dearborn, MI (US)

(72) Inventors: Saravanan Paramasivam, South Lyon, MI (US); Dave Moschet, Dearborn, MI (US); Samuel Jeffrey Tomlinson, Farmington Hills, MI (US); Samir Subba, Dearborn, MI (US)

(21) Appl. No.: 16/263,600

(22) Filed: Jan. 31, 2019

(51) Int. Cl. H01M 2/10; H01M 10/613; H01M 10/6556; H01M 10/625; H01M 10/6568

(52) U.S. Cl. CPC H01M 2/1077; H01M 10/613; H01M 2220/20; H01M 10/625; H01M 10/6568; H01M 10/6556

(57) ABSTRACT

A battery pack assembly includes, among other things, an enclosure assembly that encloses a lower tier battery array and an upper tier battery array, a lower tier heat exchanger, an upper tier heat exchanger, and a coolant channel of the enclosure assembly. The coolant channel is configured to communicate a liquid coolant between the lower and upper heat exchangers. A battery pack fluid communication method includes, among other things, fluidly coupling together a lower and an upper tier heat exchanger by securing an upper tier floor of a battery pack to a tray of the battery pack.

### TECHNICAL FIELD

This disclosure relates generally to communicating a liquid coolant between different tiers of battery arrays.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

The traction battery is a relatively high-voltage battery that selectively powers the electric machines, and potentially other electrical loads of the electrified vehicle. The traction battery can include battery arrays each including a plurality of interconnected battery cells that store energy.

In some battery packs, the battery arrays are arranged along a single tier. Other battery packs include more than one tier of battery arrays. For example, an upper tier that is vertically above a lower tier.

### SUMMARY

A battery pack assembly according to an exemplary embodiment of the present disclosure includes, among other things, an enclosure assembly that encloses a lower tier battery array and an upper tier battery array, a lower tier heat exchanger, an upper tier heat exchanger; and a coolant channel of the enclosure assembly. The coolant channel is configured to communicate a liquid coolant between the lower and upper heat exchangers.

In a further embodiment of the foregoing assembly, the coolant channel is cast within the enclosure assembly.

In a further embodiment of any of the foregoing assemblies, the enclosure provides the coolant channel such that the enclosure can directly contact liquid coolant within the coolant channel.

A further embodiment of any of the foregoing assemblies includes a tray of the enclosure assembly, an upper tier floor, and a riser provided by at least one of the tray or the upper tier floor. The riser provides the coolant channel.

In a further embodiment of any of the foregoing assemblies, securing the tray relative to the upper tier floor fluidly couples together the upper and lower heat exchangers.

A further embodiment of any of the foregoing assemblies, the lower tier heat exchanger is positioned adjacent the lower tier battery array, and the upper tier heat exchanger is positioned adjacent the upper tier battery array.

In a further embodiment of any of the foregoing assemblies, the tray of the enclosure provides a lower tier floor having the lower tier heat exchanger.

A further embodiment of any of the foregoing assemblies includes a coolant channel seal that is vertically between the tray and the upper tier floor.

In a further embodiment of any of the foregoing assemblies, the coolant channel seal is an annular seal that includes primary sealing interfaces and secondary sealing interfaces. The primary sealing interfaces are radially inside the secondary sealing interfaces. The primary sealing interfaces are axially offset from the secondary sealing interfaces.

A battery pack fluid communication method according to another exemplary aspect of the present disclosure includes, among other things, fluidly coupling together a lower and an upper tier heat exchanger by securing an upper tier floor of a battery pack to a tray of the battery pack.

A further embodiment of the foregoing method includes securing a manifold cover of the upper tier floor when securing the upper tier floor to the tray.

A further embodiment of any of the foregoing methods includes compressing an annular seal during the securing.

In a further embodiment of any of the foregoing methods, the annular seal includes at least one primary sealing interface and at least one secondary sealing interface. The at least one primary sealing interface is radially inside the at least one secondary sealing interface. The at least one primary sealing interface is axially offset from the at least one secondary sealing interface.

A further embodiment of any of the foregoing methods includes communicating a liquid coolant through a coolant channel within a riser of an enclosure.

In a further embodiment of any of the foregoing methods, the tray provides the riser.

A further embodiment of any of the foregoing methods includes exchanging thermal energy between the lower tier heat exchanger and at least one lower tier battery array, and exchanging thermal energy between the upper tier heat exchanger and at least one upper tier battery array.

In a further embodiment of any of the foregoing methods, the battery pack is a traction battery pack.

In a further embodiment of any of the foregoing methods, the upper tier floor provides at least a portion of an enclosure of the battery pack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a highly schematic view of a powertrain for an electrified vehicle.

FIG. 2 illustrates how a battery pack of the powertrain of FIG. 1 can be positioned within the electrified vehicle according to an exemplary aspect of the present disclosure.

FIG. 3 illustrates a side view of the exemplary battery pack of FIG. 2 along with a schematic view of a thermal management circuit.

FIG. 4 illustrates a section view through the exemplary battery pack taken at line 4-4 in FIG. 2.

FIG. 5 illustrates a perspective view of a selected portion of a tray from the battery pack of FIGS. 2-4.

FIG. 6 illustrates a section taken at line 6-6 in FIG. 5.

FIG. 7 illustrates selected portions of the tray and an upper tier floor from the exemplary battery pack with a manifold cover removed to reveal a coolant path associated with the upper tier floor.

FIG. 8 illustrates the portions shown in FIG. 7, but with the manifold cover, the upper tier floor, and the tray coupled together.

FIG. 9 illustrates a section view taken at line 9-9 in FIG. 8.

FIG. 10 illustrates a close-up view of a portion of the section in FIG. 9.

FIG. 11 illustrates the section view of another exemplary embodiment at the position in FIG. 10.

### DETAILED DESCRIPTION

This disclosure relates generally to communicating a liquid coolant through a battery pack having different tiers of battery arrays. In the past, battery packs with different tiers of battery arrays have required relatively complicated connections to enable a liquid coolant to be circulated to positions near the battery arrays in different tiers.

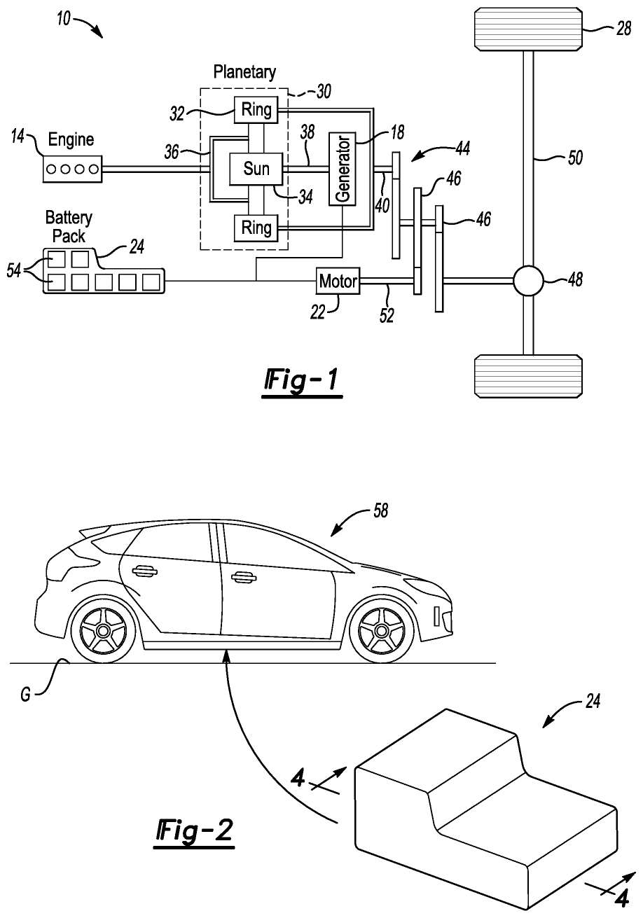

FIG. 1 schematically illustrates a powertrain 10 for an electrified vehicle. Although depicted as a hybrid electrified vehicle (HEV), it should be understood that the concepts described herein are not limited to HEVs and could extend to other electrified vehicles, including, but not limited to, plug-in hybrid electrified vehicles (PHEVs), fuel cell vehicles (FCVs), and battery electrified vehicles (BEVs).

In one embodiment, the powertrain 10 is a powersplit powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electrified vehicle.

The engine 14, which is an internal combustion engine in this example, and the generator 18 may be connected through a power transfer unit 30. In one non-limiting embodiment, the power transfer unit 30 is a planetary gear set that includes a ring gear 32, a sun gear 34, and a carrier assembly 36. Of course, other types of power transfer units, including other gear sets and transmissions, may be used to connect the engine 14 to the generator 18.

The generator 18 can be driven by engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 (i.e., the second electric machine) can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an example type of electrified vehicle battery assembly. The battery pack 24 may have the form of a high-voltage battery that is capable of outputting electrical power to operate the motor 22 and the generator 18. The battery pack 24 is a traction battery pack as the battery pack 24 can provides power to propel the vehicle drive wheels 28. The battery pack 24 includes a plurality of battery arrays 54. Each of the battery arrays 54 can include a plurality of individual battery cells, say, twenty-four individual battery cells.

With reference to FIG. 2, the battery pack 24 can be secured to an electrified vehicle 58 adjacent an underside of the electrified vehicle 58.

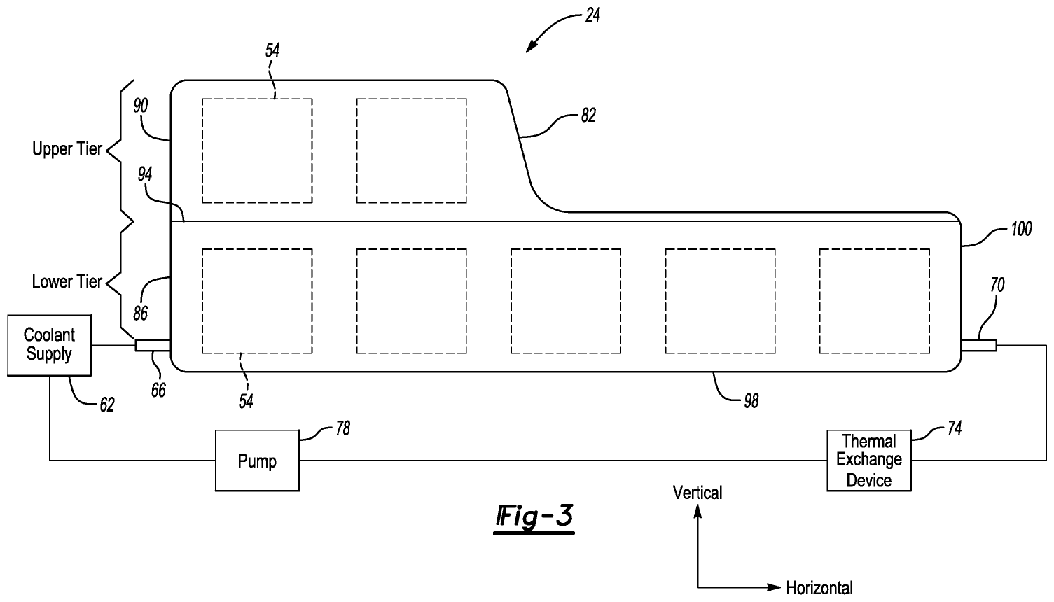

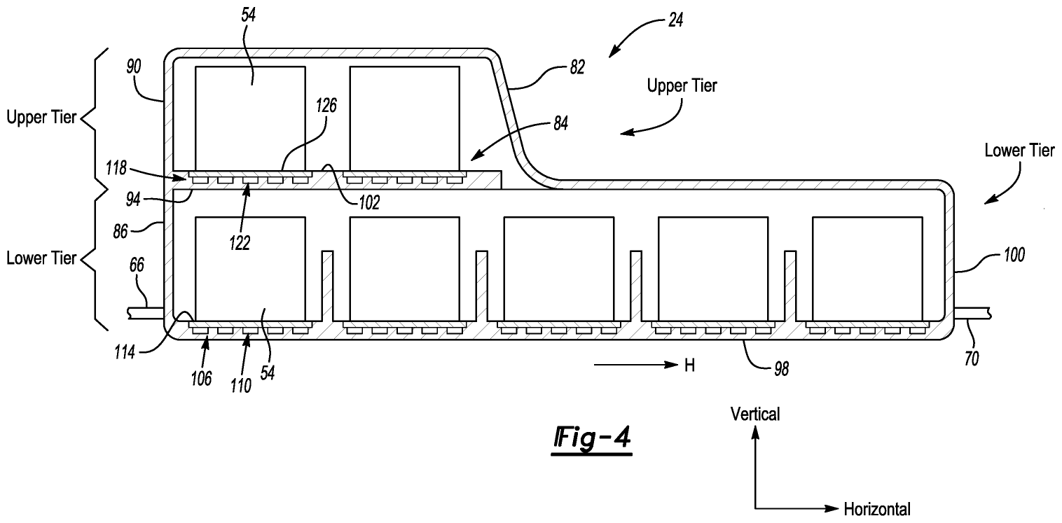

Referring now to FIGS. 3 and 4 with continuing reference to FIG. 2, the battery pack 24 is a multi-tiered battery pack, which means that the battery pack 24 includes some of the battery arrays 54 within a lower tier, and some of the battery arrays 54 within an upper tier. The upper tier is vertically above the lower tier. Vertical and horizontal, for purposes of this disclosure, are with reference to ground G and an ordinary orientation of the electrified vehicle 58 during operation.

In the exemplary embodiment, five battery arrays 54 are within the lower tier, and two battery arrays 54 are within the upper tier. Other examples could include another number of battery arrays 54 within the lower tier and another number of battery arrays 54 within the upper tier. For example, in another embodiment, the upper tier could include a single battery array 54. Further, while the exemplary embodiment includes two tiers (i.e., the upper tier and the lower tier), other example multi-tier battery packs could include more than two tiers.

Utilizing the multi-tiered battery pack 24 may be beneficial to address packaging concerns. For example, the battery pack 24 having the multi-tiered arrangement may be packaged more effectively beneath the electrified vehicle 58 than if the battery arrays 54 were instead all arranged within a single tier. Positioning all seven of the battery arrays 54 within a single tier could increase an overall horizontal length of the battery pack. Positioning two of the battery arrays 54 within the upper tier as shown can decrease a horizontal length of the battery pack 24 when compared to a battery pack having all the battery arrays within a single tier.

The battery arrays 54 can require thermal management. For example, during operation, cooling the battery arrays 54 may be required. In this example, a liquid coolant is used to cool the battery arrays 54. In another example, the liquid coolant could selectively be used to instead heat the battery arrays.

In the exemplary embodiment, the liquid coolant is moved from a coolant supply 62 through an inlet 66 that opens to the battery pack 24. The liquid coolant is circulated through various areas of the battery pack 24 to take on thermal energy from the battery arrays 54 and, potentially, other components of the battery pack 24.

The liquid coolant, once heated, moves from the battery pack 24 through an outlet 70 to a thermal exchange device 74, such as a liquid-to-air heat exchanger. At the device 74, thermal energy is transferred away from the liquid coolant to air. The liquid coolant then moves back to the coolant supply 62 to complete a coolant circuit. A pump 78 can be used to assist movement of the liquid coolant along the coolant circuit.

The battery pack 24 includes an enclosure assembly 82 providing an interior 84. The battery arrays 54 are held within the interior 84 and enclosed within the interior 84 by the enclosure assembly 82. In this example, the battery arrays 54 are completely surrounded by the enclosure assembly 82. Among other things, the enclosure assembly 82 can protect the battery arrays 54 from debris and damage.

The enclosure assembly 82 includes a tray 86 and a lid 90. The tray 86 and the lid 90 can each be cast from a metal or metal alloy, but other material compositions are possible and fall within the scope of this disclosure. The tray 86 interfaces directly with the lid 90 along an interface 94. The interface 94 extends circumferentially about an entire perimeter of the enclosure assembly 82. Mechanical fasteners can be used to secure the tray 86 to the lid 90 at the interface.

The tray 86, in the exemplary embodiment, provides a lower tier floor 98 and sidewalls 100 extending vertically upward from the lower tier floor 98 to the interface 94. The battery arrays 54 of the lower tier are disposed on the lower tier floor 98.

The battery pack 24 further includes an upper tier floor 102. The battery arrays 54 of the upper tier are disposed on the upper tier floor 102. In this example, all portions of the upper tier floor 102 are housed within the interior 84 of the enclosure assembly 82. In another example, the upper tier floor 102 could provide some part of the enclosure assembly 82. In such an example, the upper tier floor 102 could extend outwardly from the interior 84 and include a portion held between the tray 86 and the lid 90 at the interface 94.

The lower tier floor 98 includes a plurality of lower heat exchangers 106 each disposed vertically beneath one of the battery arrays 54 within the lower tier. The lower heat exchangers 106 include channels 110 covered by a lid 114.

In this example, the battery array 54 of the lower tier are each disposed on one of the lids 114. A thermal interface material (TIM) could be positioned between the lids 114 and the battery array 54 of the lower tier to facilitate thermal energy transfer between the battery array 54 and the associated lower heat exchanger 106.

In the exemplary embodiment, the channels 110 are formed within the tray 86. Other configurations, however, are contemplated and fall within the scope of this disclosure. For example, some portion, or all, of the channels 110 could instead be formed within the lid 114.

An upper heat exchanger 118 is disposed vertically beneath each of the battery arrays 54 within the upper tier. The upper heat exchangers 118 include channels 122 covered by a lid 126.

In this example, the battery array 54 of the upper tier are each disposed on one of the lids 126. A TIM could be positioned between the lids 126 and the battery array 54 of the upper tier to facilitate thermal energy transfer between the battery arrays 54 and the associated upper heat exchanger 118.

In the exemplary embodiment, the channels 122 are formed within the upper tier floor 102. Other configurations, however, are contemplated and fall within the scope of this disclosure. For example, some portion, or all, of the channels 122 could instead be formed within the lid 126.

Referring again to the coolant circuit, the liquid coolant, after entering the inlet 66, can move through the channels 110, 122 to take on thermal energy from the battery arrays 54 of the upper and lower tiers. In another example, the coolant circuit could be used to provide thermal energy to the battery arrays 54. That is, in some examples, the coolant circuit, lower heat exchangers 106, and upper heat exchangers 118 could be used to heat, rather than cool, the battery arrays 54.

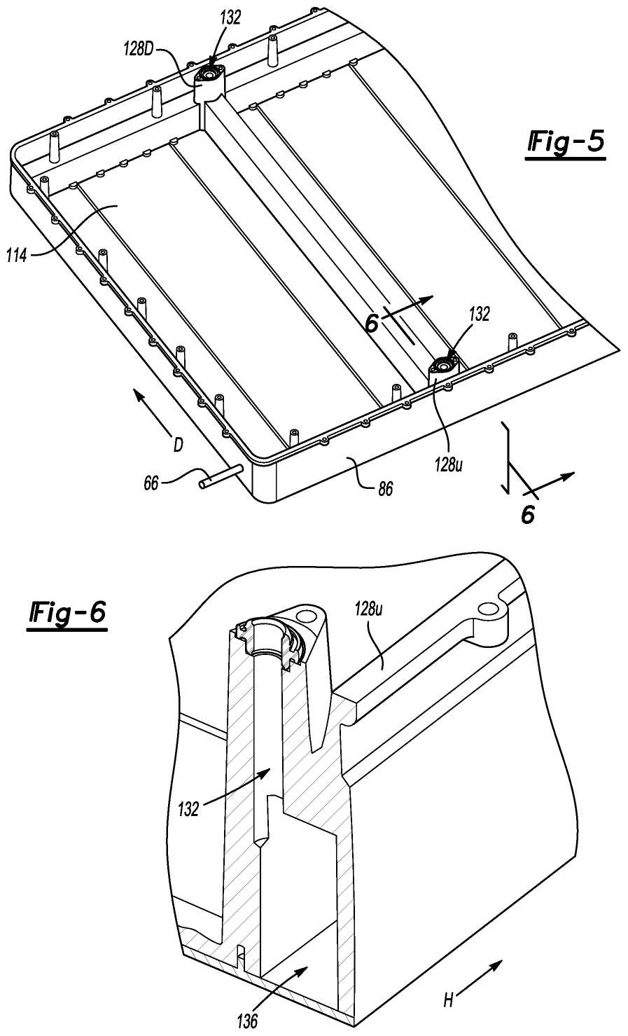

With reference now to FIGS. 5-7 and continuing reference to FIGS. 3 and 4, the tray 86, in the exemplary embodiment, includes risers 128U, 128D. Within each of the risers 128U, 128D is a coolant channel 132 that is used to communicate the liquid coolant between the upper and lower tiers. In the exemplary embodiment, the coolant channels 132 are provided within the risers 128U, 128D and thus integrated within the tray 86, which is part of the enclosure assembly 82. Liquid coolant within the coolant channels 132 can thus come into direct contact with the enclosure assembly 82 because the liquid coolant is not contained within a pipe or tube separate from the enclosure assembly 82.

The risers 128U, 128D can be cast together with the remaining portions of the tray 86. The coolant channels 132 can be machined into the risers 128U, 128D or cast into risers 128U, 128D, for example.

In this example, the coolant channel 132 within the riser 128U is used to communicate liquid coolant vertically upward from the tray 86 to the upper tier floor 102. The coolant channel 132 is used to communicate liquid coolant vertically downward from the upper tier floor 102 to the tray 86. The pump 78 can be used to move the liquid coolant.

As fluid moves from the inlet 66 to the battery pack 24, the liquid coolant initially enters a lower inlet manifold 136 (FIG. 6) of the tray 86. The lower inlet manifold 136 extends horizontally along a side of the tray 86 in a direction H (see also FIG. 4). The channels 110 of the lower heat exchangers 106 open to the lower inlet manifold 136. The coolant channel 132 within the riser 128U also opens to the lower inlet manifold 136. From the lower inlet manifold 136, some of the liquid coolant moves in a direction D through the channels 110 of the lower heat exchangers 106, and some of the liquid coolant moves vertically upward through the coolant channel 132 provided by the riser 128U.

The liquid coolant that has moved through the coolant channel 132 of the riser 128U flows along a path P (FIG. 7) into a upper inlet manifold 140 extending horizontally in the direction H along the upper tier floor 102. The channels 122 of the upper heat exchangers 118 open to the upper inlet manifold 140. From the upper inlet manifold 140, the liquid coolant moves through the channels 122 across the upper tier floor 102 in the direction D.

After the liquid coolant has circulated through the channels 122, the liquid coolant, now heated by the battery arrays 54 within the upper tier, moves into a upper outlet manifold (not shown) on a side of the upper tier floor 102 opposite the upper inlet manifold 140. The liquid coolant then flows downward through the coolant channel 132 provided by the riser 128D and into a lower outlet manifold of the tray 86 on an opposite side of the tray 86 from the lower inlet manifold 136.

The lower outlet manifold of the tray 86 also collects (now heated) liquid coolant that has passed through the channels 110 within the lower heat exchangers 106.

The liquid coolant is then moved from the lower outlet manifold, and from the battery pack 24, through the outlet 70.

In this exemplary embodiment, an inlet other than the inlet 66, and an outlet other than the outlet 70 are not required to circulate the liquid coolant through the lower heat exchangers 106 and the upper heat exchangers 118. That is, separate upper tier and lower tier inlets are not required. However, more than one inlet, more than one outlet, or both, could be used as required without departing from the teachings of this disclosure.

Notably, the coolant channels 132 are provided by the risers 128U, 128D, which are part of the tray 86 and thus part of the enclosure assembly 82. The coolant channel 132 could, in another example, be at least partially provided by a portion of the upper tier floor 102.

In the past, to communicate fluid between tiers of multi-tiered battery packs, some designs have used dedicated conduits separate from the enclosure and other structures. These dedicated conduits, such as tubes and pipes, are dedicated to communicating liquid coolant. The dedicated conduits can require complicated assembly techniques and contribute to overall build complexity. Coupling together quick-connect connectors, for example, could be required to fluidly couple together such tubes and pipes.

In contrast to previous approaches, the coolant channels 132 in an exemplary embodiment of this disclosure can fluidly couple the upper tier floor 102 and the tray 86 as the upper tier floor 102 and the tray 86 are assembled. This can simplify the assembly process over previous designs utilizing separate tubes and pipes.

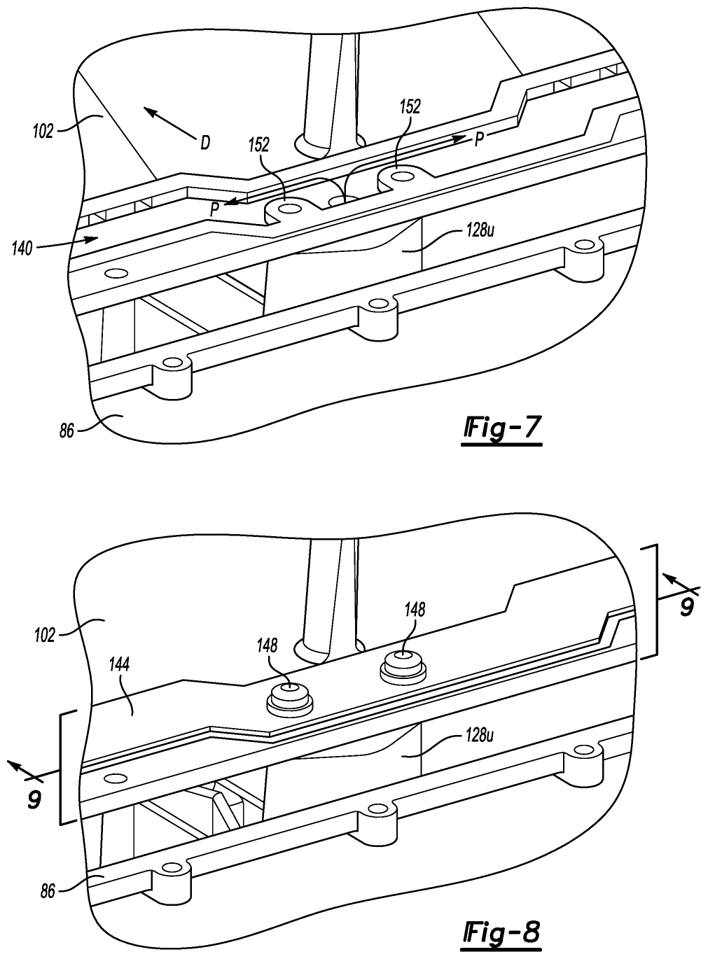

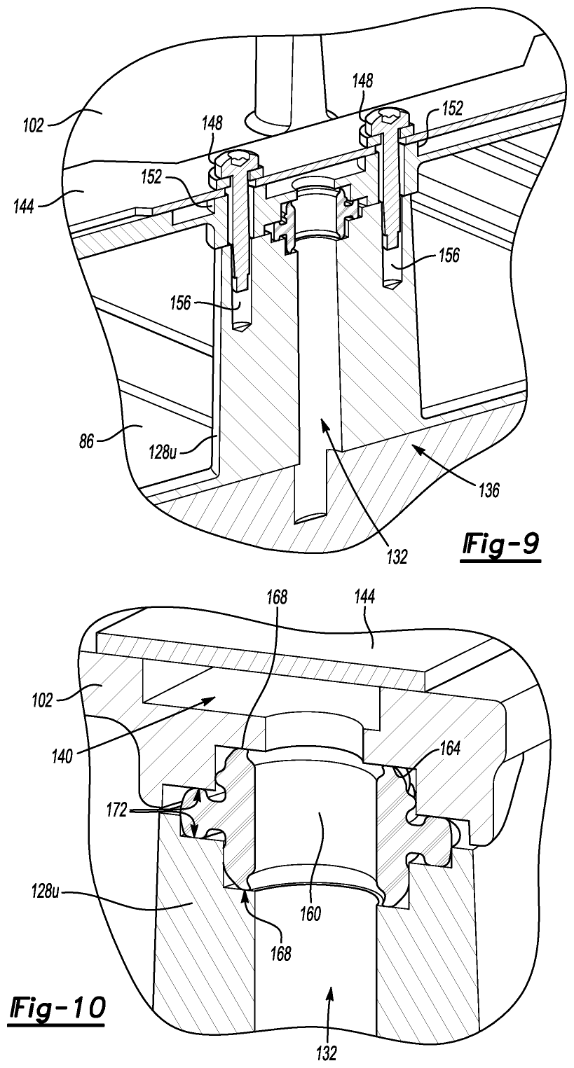

During assembly, the upper tier floor 102 is first positioned on the riser 128U of the tray 86 as shown in FIG. 7. A manifold cover 144 is then positioned over the upper inlet manifold 140 and secured in place utilizing at least one mechanical fastener 148 as shown in FIG. 8. The mechanical fasteners 148 extend through the manifold cover 144 and through bosses 152 of the upper tier floor 102 to engage threaded bores 156 of the riser 128U as shown in FIG. 9.

The mechanical fasteners 148 secure together the manifold cover 144, the upper tier floor 102, and the tray 86 via threaded engagement with the riser 128U of the tray 86. Once the upper tier floor 102 and the tray 86 are secured together as described, the lower inlet manifold 136 is fluidly coupled to the upper inlet manifold 140 by the coolant channel 132. Thus, securing the tray 86 relative to the upper tier floor 102 fluidly couples together the upper heat exchangers 118 and the lower heat exchangers 106. The opposite lateral side of the upper tier floor 102 is similarly coupled to the riser 128D.

With reference now to FIG. 10, the exemplary embodiment uses a coolant channel seal 160 to seal an interface between downwardly facing surfaces 164 of the upper tier floor 102 and the riser 128U. A similar coolant channel seal can be used to seal an interface between the riser 128D and the upper tier floor 102. The coolant channel seal 160 is an annular seal that is distributed about the coolant channel 132 and provides a portion of a perimeter of the coolant channel 132. The example coolant channel seal 160 is situated vertically between the upper tier floor 102 and the riser 128U. The coolant channel seal 160 is compressed between the riser 128U and the upper tier floor 102 as the mechanical fasteners 148 are torqued down into the threaded bores 156.

The coolant channel seal 160 includes primary sealing interfaces 168 and secondary sealing interfaces 172. The primary sealing interfaces 168 are radially inside the secondary sealing interfaces 172. Further, the primary sealing interfaces 168 are axially offset from the secondary sealing interfaces 172.

As liquid coolant moves through the coolant channel 132, leakage of the liquid coolant from the coolant channel 132 is blocked initially by the primary sealing interfaces 168. The secondary sealing interfaces 172 block any liquid coolant that slips radially outward past the primary sealing interfaces 168. The secondary sealing interfaces 172 can prevent this fluid from escaping into an interior of the battery pack 24.

In the past, the dedicated conduits used to communicate fluid between tiers of multi-tiered battery packs may have been positioned in areas near the battery arrays. Leakage from these dedicated conduits could undesirably leak liquid coolant near the battery arrays. The positioning of the coolant channel 132 within the enclosure assembly 82 can help to avoid leakages into areas near the battery arrays 54. The primary sealing interfaces 168 and the secondary sealing interfaces 172 can further inhibit leakage into areas near the battery arrays 54.

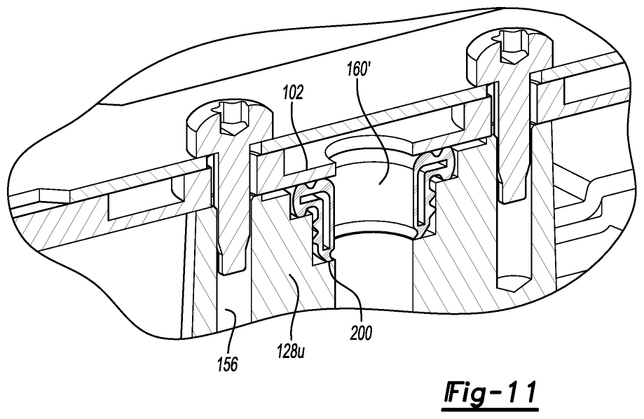

With reference to FIG. 11, another exemplary embodiment can include a coolant channel seal 160′ that is an annular seal and has multiple sealing interfaces 200 with the riser 128U and the upper tier floor 102. Like the coolant channel seal 160, the multiple sealing interfaces 200 of the coolant channel seal 160′ can help to block liquid coolant from leaking into areas near the battery arrays 54.

Features of the disclosed examples include a heat exchanger of an upper tier that can be fluidly coupled to a heat exchanger of lower tier by securing the upper tier relative to the lower tier. The coolant channel can be integrated into the enclosure of the battery pack.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A battery pack assembly, comprising:
an enclosure assembly that encloses a lower tier battery array and an upper tier battery array;
a lower tier heat exchanger;
an upper tier heat exchanger; and
a coolant channel of the enclosure assembly, the coolant channel configured to communicate a liquid coolant between the lower and upper heat exchangers.

2. The battery pack assembly of claim 1, wherein the coolant channel is cast within the enclosure assembly.

3. The battery pack assembly of claim 1, wherein the enclosure provides the coolant channel such that the enclosure can directly contact liquid coolant within the coolant channel.

4. The battery pack assembly of claim 1, further comprising a tray of the enclosure assembly, an upper tier floor, and a riser provided by at least one of the tray or the upper tier floor, wherein the riser provides the coolant channel.

5. The battery pack assembly of claim 4, wherein securing the tray relative to the upper tier floor fluidly couples together the upper and lower heat exchangers.

6. The battery pack assembly of claim 4, wherein the lower tier heat exchanger is positioned adjacent the lower tier battery array, and the upper tier heat exchanger is positioned adjacent the upper tier battery array.

7. The battery pack assembly of claim 4, wherein the tray of the enclosure provides a lower tier floor having the lower tier heat exchanger.

8. The battery pack assembly of claim 4, further comprising a coolant channel seal that is vertically between the tray and the upper tier floor.

9. The battery pack assembly of claim 8, wherein the coolant channel seal is an annular seal that includes primary sealing interfaces and secondary sealing interfaces, the primary sealing interfaces radially inside the secondary sealing interfaces, the primary sealing interfaces axially offset from the secondary sealing interfaces.

10. A battery pack fluid communication method, comprising:
fluidly coupling together a lower and an upper tier heat exchanger by securing an upper tier floor of a battery pack to a tray of the battery pack.

11. The battery pack fluid communication method of claim 10, further comprising securing a manifold cover of the upper tier floor when securing the upper tier floor to the tray.

12. The battery pack fluid communication method of claim 10, further comprising compressing an annular seal during the securing.

13. The battery pack fluid communication method of claim 12, wherein the annular seal includes at least one primary sealing interface and at least one secondary sealing interface, the at least one primary sealing interface radially inside the at least one secondary sealing interface, the at least one primary sealing interface axially offset from the at least one secondary sealing interface.

14. The battery pack fluid communication method of claim 10, further comprising communicating a liquid coolant through a coolant channel that is within a riser of an enclosure.

15. The battery pack fluid communication method of claim 14, wherein the tray provides the riser.

16. The battery pack fluid communication method of claim 10, further comprising exchanging thermal energy between the lower tier heat exchanger and at least one lower tier battery array, and exchanging thermal energy between the upper tier heat exchanger and at least one upper tier battery array.

17. The battery pack fluid communication method of claim 10, wherein the battery pack is a traction battery pack.

18. The battery pack fluid communication method of claim 10, wherein the upper tier floor provides at least a portion of an enclosure of the battery pack.
